(19) United States
(12) Patent Application Publication
(10) Pub. No.: US 2006/0039455 A1
(43) Pub. Date: Feb. 23, 2006

(54) Composite waveform for transmitting an increased amount of data over an analog medium, and devices and methods for producing, encoding, transmitting and decoding same

(75) Inventors: John P. Cairns, Mclean, VA (US); Anthony Hobbs-Boiardi, Mclean, VA (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Quamtum Advanced Technologies, Inc.

(21) Appl. No.: 11/081,835

(22) Filed: Mar. 17, 2005

Related U.S. Application Data
(60) Provisional application No. 60/554,756, filed on Mar. 19, 2004.

(51) Int. Cl. H04B 1/38

(52) U.S. Cl. 375/222

(57) ABSTRACT

The present invention is directed towards data transmission over telecommunications networks, and more specifically towards a system and method for enabling high-speed communications through the use of a composite waveform for transmitting an increased amount of data. The present invention has particular application to high-speed data transmissions over analog telephone communication networks.

### CROSS REFERENCE TO RELATED APPLICATIONS

The present invention claims priority from U.S. Provisional Application No. 60/___,___ filed on Mar. 17, 2004, entitled “COMPOSITE WAVEFORM FOR TRANSMITTING AN INCREASED AMOUNT OF DATA OVER AN ANALOG MEDIUM, AND DEVICES AND METHODS FOR PRODUCING, ENCODING, TRANSMITTING AND DECODING SAME,” the inventors of whom are Anthony HOBBS and John P. CAIRNS, the subject matter of which is hereby incorporated by reference in full.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The present invention is directed towards data transmission over telecommunications networks, and more specifically towards a system and method for enabling high-speed communications through the use of a composite waveform for transmitting an increased amount of data. The present invention has particular application to high-speed data transmissions over analog telephone communication networks.

2. Discussion of the Related Prior Art

Many communications environments, such as the analog telephone system, are hostile to digital pulsed input. Specifically, a sinusoidal wave used in an analog communication system is slow because it fills the zero crossing points with dead time due to its geometry. An analog environment has a time interval during which the electrical field intensity vector and/or magnetic field intensity vector are present for the time duration. The time duration below the limiting time value are regarded as noise transients.

In response, modems were developed to meet a need to send digital computer data over the analog telephone network. Put simply, modem stands for “modulation and demodulation” and modems are boxes of electronics that sit at both ends of a computer-to-computer connection over the telephone network. The modem at the sending end of a connection takes the digital signal from the computer and modulates it onto the electrical carrier wave, which would otherwise carry the voice signal in analog form, down the telephone line and across the network. Modulation means changing the form of the carrier wave in a way that encodes the data to be transmitted. In the known modem technology, modulation includes a process of impressing information on a carrier wave by changing some of the wave's characteristics (such as amplitude, frequency, or phase) to reflect the changes in the information it delivers. For example, the amplitude levels in a carrier wave may be modified to reflect the values of transferred bits (0's and 1's), with zero values associated with low amplitudes and one values associated with high amplitude values.

A modem allows electronic devices such as computers to transmit data over regular wired or wireless communication systems. Thus, modems enable computer-to-computer communications over an analog telephone network. Computers store, send, receive and process data in digital format. In other words, the data in a computer is stored as a series of binary digits or bits. Communication systems, however, usually transmit data in continuous analog waves. A modem converts the signal from digital format to analog format for transmission to a remote modem in a modulation process. Encoded with the data, a carrier wave travels across the network just as if it was an ordinary voice signal transmission. The modem at the receiving end of the connection demodulates the carrier wave, converting the encoded data back into a stream of digits for the receiving computer. When a modem receives a signal from a remote source, it reconverts the incoming analog signal into a digital signal in a demodulation process so that a receiving computer can handle the data. Normally modems have the capability to both send and receive data, although often their performance is asymmetrical. For example, certain modems may be able to receive data at a high speed but to send only at a low speed.

Modems are designed to work in specific types of modulation schemes, as each modem should include the ability to encode and decode, modulate or demodulate a specific carrier wave. Various modulation schemes are well known in the field of digital data transmission, and a full description of theses various known modulation schemes is generally beyond the scope of the present discussion.

In the past, the telephone network was analog such that electronic signals representing voicing communications were carried throughout the entire network. Beginning in the 1970s, the worldwide telephone network become increasingly digital, whereby analog voice transmissions are converted into digital data waves for transmission through the communication network, and the digital data waves are reconverted into an analog format at the receiving end. The digital telephone networks are well known technology that operate by sampling the analog signals, converting the analog signal samples into discrete values, and converting the discrete values into a corresponding data wave. At the receiving end, the data wave is received and converted back into the discrete values. An analog voice signal is then created corresponding to the received discrete values. The digital network, predominantly optical networks, allowed increased bandwidth with improved audio quality. In particular, the digital networks can transmit signals over extended distances with minimal information loss. Today, only the local loops or central offices (“CO”), the wires connecting homes and offices to their local telephone exchanges, are predominantly analog, so called last mile.

The digitalization of voice communications has influenced data communications by modem. A sending modem still modulates the digital signal onto an analog wave as before, but now, the data wave travels in an analog form only on the local loop. When the signal reaches the central office, it goes through an analog-to-digital (A/D) conversion and travels in a digital form across the main backbone of the network. When it reaches the local loop to the destination modem, the data signal is changed back into analog form through a digital-to- analog (D/A) converter. Finally, when the data wave reaches the destination modem in an analog form, is demodulated back into digital computer data.

Modems for use on the public telephone network have made numerous advances in their data rate or speed of operation over the last 30 years, from 300 bps (bits per second) in the late 1960s to 33.6 Kbps (thousands of bits per second) with the V.34 modem introduced in 1994. But 33.6 Kbps is about the highest practical speed for conventional modems because of the limits imposed by the nature of the network and the local loop. Achieving even higher data rates demanded a radically different approach.

The ultimate limit to the amount of information to be transmitted over a given communications link can be calculated using Shannon's theorem. Shannon showed that the information capacity of a communications channel is directly proportional to its bandwidth and “signal-to-noise” ratio. Bandwidth has a similar relationship to communications capacity as the diameter of a pipe has to the volume of flowing water. The signal-to-noise ratio measures the strength of the signal compared to all the interference it encounters from different sources on its journey. In most modern communication systems, the signal strength is many times the noise level, and from Shannon's theorem, this means that the potential communications capacity is several times greater than the bandwidth.

For communications over current telephone networks, the biggest source of noise is usually caused by the analog-to-digital for onward transmission over the network. Representing a continuous analog signal as a sequence of separate pulses at fixed intervals necessarily means losing some information. This effect is called quantization noise and limits a conventional modem transfer rates to a maximum of about 33 to 45 Kbps. The exact level depends on the characteristics of the local loop. Thus, a V.34 modem that sends and receives data at 33.6 Kbps under is coming close to the theoretical limit introduced by the sampling noise.

The possibility of sending data on an ordinary telephone line at faster rates, up to 56 Kbps, was opened up by exploiting the digital characteristics of the telephone network rather than ignoring them. Voice signals travel across modern telephone networks in digital form encoded by a technique called pulse code modulation, or PCM. V.PCM modems, such as those following the V.90 standard, make use of the same format used for voice signals. PCM data transfer typically occurs where the user is accessing the Internet through an Internet service provide (“ISP”) over an analog local loop. The modem at the ISP, or server-side, may be different from the modem at the end-user, or client-side, because the ISP, like most large businesses and heavy users of data communications, often has a high-bandwidth digital connection to the telephone network, such as a T1 circuit in North America, an El circuit in Europe or an ISDN PRI (primary rate interface). The ISP server-side modem is effectively a digital coder-decoder (“codec”) that takes the data received over the Internet and encodes it in the same PCM format used in the telephone network. The data passes unchanged over the ISP network connection and the telephone network without any D/A or A/D conversion until it arrives at the local loop to the end user. There, the telephone network carries out a D/A conversion as it would for a voice call. The client-side modem at the user end decodes the voice-like analog signal and converts it back into computer data.

In this way, V.90 and other V.PCM standards circumvents data transmission limits caused by quantization noise by avoiding the need for quantization, at least in the downstream direction. More specifically, the V.PCM standards transmit data in digital form as a sequence of PCM symbols from the central site modem. Because there is no analog-to-digital conversion as the signals propagates across the network, no quantization noise occurs.

Where an end user is connected to the telephone network by an analog local loop, the V.PCM coding format applies only in the downstream direction, from the ISP to the end-user's modem. Data going in the other direction, upstream from the client-side modem, is encoded by conventional techniques, so the speed is limited to 33.6 Kbs. Encoding upstream data in V.PCM format does not work because the coding is lost in going through the A/D conversion at the telephone exchange.

The ultimate limit to capacity is set by the PCM coding scheme itself. The international standards for digital telephony provide that the PCM signal is encoded by taking a sample of the voice signal 8,000 times a second and representing the value of the sample as an 8-bit number or symbol. With 8 bit samples taken 8,000 times per second, the digital telephone data rate is 64 Kbps. Eight bits can be represented by 256 distinct signal levels, so in effect, the encoder is representing the value of each sample of the voice signal to an accuracy of one part in 256.

In practice, by the time the voice signal has been converted from analog to digital, transported across the digital network and the local loop, and reconverted from digital to analog, much of the fine data detail may be lost. This loss in not important for ordinary telephone voice communications because the human ear is tolerant of certain errors and interference, but the loss is unacceptable for data transmission. To minimize data loss, some of the potential data rate is sacrificed to deliver improved, acceptable accuracy. Instead of trying to read a signal with 256 distinct levels, the current generation of V.PCM modems strives to distinguish a maximum of 128 levels, chosen to be more widely and reliably spaced. One hundred and twenty-eight are enough to encode 7 bits, so the maximum data rate falls back to times 7 bit samples taken 8,000 times per second, or 56 Kbps.

56 Kbps data transmissions cannot normally be achieved, mainly because of communication network defects called impairments, both on the analog local loop and on the digital telephone network. The signal processing software running in a V.PCM modem applies various techniques to identify the impairments and correct for them, but this typically involves reducing the number of distinguishable signal levels to maintain accuracy, reducing the actual achieved data rate, generally in the range of 42 to 49 Kbps. If these signal processing techniques fail due to particular phone network limitations, then the modem reverts to operating according to the V.34 standard at a maximum of 33.6 Kbps.

A variety of impairments affect the transmission of digital data and have to be taken into account in modem design. Digital impairments are irrelevant to V.34 and earlier modems that treat the network as a transparent transmission channel, but they can have a significant effect on the performance of V.90 modems. To some extent the impairments are accommodated in the V.PCM modems by sacrificing one bit and transferring 7-bit (and not 8-bit symbols). Where the impairments are severe, they further reduce the effective data rate below 56 Kbps. One type of digital impairments that affect V.90 performance is the use of “rob bits” in the digital telephony standard used in North America and Japan, in which 1 bit is periodically stolen from voice sample code for signaling or control purposes. Another source of digital impairments is the use of “pads” in the network that apply a type of digital filtering to the signal. Further digital impairment are caused by the barring of some 8-bit codes altogether and reserving these particular codes for network purposes. The DIL (digital impairment learning) function in the V.90 modem exists to minimize the effects of these and other digital impairments, but the digital impairments still limit data transfer rates.

While the signal-to-noise ratio over the local loop is generally high enough to support 56 Kbps communications in theory, but other issues related to sampling limit data transfer rates. As described above, when analog data are transmitted over the telecommunications network, the codec equipment at the telephone central office (CO) samples and quantizes the analog signals traveling through the analog loops at a frequency of 8 kHz. The sampling clock of the CO codec has a fixed frequency at 8000 samples/sec set by the network. The 8 kHz sampling rate standard is utilized throughout the entire digital portion of the telecommunications network. The sampling rate of the analog signal is important because it determines the quality of the signal that is generated when the digital signal is converted back to analog form.

The Nyquist theorem states that, in order to accurately reconstruct a sampled analog signal, the sampling rate used must be greater than or equal to two times the maximum frequency component present in the band limited signal. For example, if the maximum frequency component present in an analog signal is 250 kHz, the signal must be sampled at a minimum of 500 kHz in order to be able to recover the signal from the samples with minimal information loss. Consequently, the Nyquist limit provides that the number of symbols carried over a communications channel is limited to two times its bandwidth, in order to accurately recover the original data. If this criterion is not satisfied, erroneous data values patterns may be generated in a phenomenon broadly called “aliasing.” Aliasing may be minimized through various filtering techniques (e.g., an commercially available anti-aliasing filter employs a low pass filter), but these techniques may remove important data.

Because of the Nyquist limit, the sampling rate used by telephone central office switching equipment (8 kHz) imposes a maximum frequency of 4 kHz on signals that can be passed through the telecommunications network from an analog loop. Consequently, a voice telephone channel with a bandwidth of 4 kHz (4,000 cycles per second) can theoretically carry up to 8,000 symbols per second, giving a full 64 Kbps communications capacity with 8-bit symbols, or the 56 Kbps of the V.90 standard with 7-bit symbols. A bandwidth of 4 kHz provides for acceptable quality voice transmission without requiring higher speed sampling requirements and equipment. However, for data transmission, this bandwidth limit is problematic and cannot be overcome since there is no available extra bandwidth.

However, the actual voice telephone bandwidth provided on a local loop is often less than 4 kHz. Traditionally, the telephone networks have aimed to provide a voice bandwidth of at least 3 kHz, so the effective bandwidth may be only 3 or 3.5 kHz, giving a maximum data rate of 42 to 49 Kbps for 7-bit symbols. The actual outcome is not clear-cut because the voice bandwidth is not sharply defined in practice. A modem should operated to make the best use of available capacity. Maximizing available bandwidth typically entails achieving synchronization with the PCM signals over the digital part of the network, negotiating an encoding scheme with the central site modem, and shaping the data signal to fit the transmission characteristics of the local loop at different bandwidths.

Besides bandwidth limitations, a given local loop may also have an unduly low signal-to-noise ratio, thereby causing data transmissions according to Shannon's theory. A low signal-to-noise ratio may occur, for instance, if the user is located far from the telephone exchange. Similarly, a low signal-to-noise ratio may have local causes, such as telephone cabling that is subjected to cross-channel or electrical interference when it runs in parallel with other cables in the user's building. Having multiple communication equipment on the same line as the Internet connection may also reduce performance.

In response to these limits in data transfers over conventional telephone lines, alternative data transfer techniques have been implemented. Asymmetric digital subscriber line , or “ADSL,” modems (asymmetric because the modem sends-data faster in one direction) take advantage of the fact that virtually any residence or office has a dedicated hard line running directly to a near central office. This dedicated line can carry far more data than the 3,000-hertz signal needed for a phone voice channel. By equipping both the phone company's central office and user with ADSL modems connected to the hard line, then the hard line can act as a purely digital, high-speed transmission channel. The hard line has a high data capacity because no sampling or transformations occur. The ADSL capacity is in the neighborhood of 1 million bits per second (Mops) between the user and the phone company (upstream) and 8 Mbps between the phone company and the user (downstream) under ideal conditions. The same line can transmit both a phone conversation and the digital data.

An ADSL modem operates on simple principles to exploit the greater bandwidth and signal-to-noise ratio available on a dedicated communication line. A phone line's bandwidth between 24,000 hertz and 1,100,000 hertz is divided into 4,000-hertz bands, and a virtual modem is assigned to each of the 249 bands. The aggregate of the 249 virtual modems is the total speed of the pipe. However, the ADSL modems and other similar technologies for creating separate data channels are relatively expensive to implement. Furthermore, the telephone networks in many areas of the countries are not capable of ADSL data transfers. Moreover, the ADSL modems require users to use the telephone company as an intermediary, thereby not allowing users to communicate directly.

According, there is a present need for a system and method for enabling high-speed communications within the technical confines of an analog communication network such as conventional telephone networks.

### SUMMARY OF THE INVENTION

In response to these and other needs, the present invention provides a system and method for enabling high-speed communications through a composite waveform for transmitting an increased amount of data. Unlike the existing modem technology, the present invention does not change the carrier wave characteristics as a method of modulation. Rather, the present invention forms a data wave (or digital wave) representing the transmitted data and appends the digital wave to a carrier wave (or sine voice wave), creating a composite wave for transmission over a communication medium such as a telephone network. At the receiving end, the composite wave is then separated into the two constituent waves by a demultiplexer. The sine voice wave is stripped and discarded, and the digital wave is processed (demodulated) to reacquire the transmitted data. In this way, the present invention enables data transmissions over a voice channel that exceeds data rates achieved by previously known modems and modulation schemes.

A composite waveform transmission method of the present invention generally comprises the steps of grouping the digital data, converting the groups of digital data into a high speed data signal, and combining the data signal with a carrier signal adapted for transmission on the communications network. The composite signal is then transmitted on the communications network. At the receiving end, the composite signal is received and the data signal is recovered by separating the carrier signal. The recovered data signal is then demodulated into digital data.

The digital data is in the form of bits representing, one or zero values. Eight combined bits equals one byte of data, and the input data may be organized into data bytes or other data groupings. The first procedure in passing a digital wave is to produce optimized voltage pulses with an amplitude within the resolution of the receiver. These pulses are closely packed and are of fixed amplitude for a given time interval. The data groupings are then placed in an input register of corresponding size that is connected to the weighted resistive array (or ladder) that generates a voltage pulse of fixed time duration. The resulting voltage amplitude is a weighted output, and this weighted output is a function of the resistive array configuration. In this way, the weighted resistive array converts the grouped digital input into an analog voltage level, where each of the possible data grouping values has a unique associated voltage level. This voltage level is generally maintained for a time as needed to emulate the analog wave. The weighted resistive array preferably has a minimum Eigen value, thereby ensuring that that data values may be recovered from the formed voltages through a reverse process.

The sequential data strobe then loads the register with a new data byte (or other data grouping). This process may then be repeated for 8 bytes, forming a grouping of 8 voltage levels representing 2⁸ or 256 possible values ranging from 0 to 255, as shown here:
0=00000000,
1=00000001,
2=00000010,
. . .
254=11111110, and
255=11111111.

Each of the possible byte values may be associated with a unique ASCII code symbol (a well-defined set of 256 computer characters). An analog electronic wave, corresponding to each of the ASCII code symbol may then be produced using the weighted resistive array and the sequential data strobe.

In one particular implementation, the modem of the present invention has a digital-to-analog converter (DAC) that includes a weighted resistive array, a sequential data strobe, and a divide-by-N register. The operation of these components is summarized below. However, it should be appreciated that other DACs (such as commercially available operational amplifiers) are known and may be used in the present invention.

The divide-by-N register may be used to append a ninth analog data value to the data wave to indicate the start or end of the data grouping. This typically places a “0” value in the output data wave sequence. Thus, this “0” input added by the weighted analog converter data forms a clock signal representing the start or stop of the data pulse. In this way, the data is converted into a data signal comprising groupings of nine voltages.

The modem of the present invention further includes a carrier wave generator and a multiplexor (or mixer). Typically, the carrier wave generator produces an analog sine wave. Preferably, the analog sine transport wave has a frequency of 8 kHz to match the maximum sampling limit of the telephone communication network, as described above. The mixer then combines the analog sine wave and the data signal, resulting in a stepped sine wave. The steps are generally unequal in length and represent the embedded data signal contained in the analog wave.

A corresponding modem operates at the receiving end to receive and process the transmitted stepped sine wave (composite wave). The receiving modem contains a demultiplexor that separates the data signal from the stepped sine wave. The data signal is then decoded to reproduce the transferred data. For example, a voltage meter may be used to detect each of the discrete voltage levels, and a decoding table may associate each of the detected voltage levels with bit values. In this way, a series of voltage signals may be decoded into digital signals. It should be appreciated that numerous known devices may be employed to demodulate the data signal.

In another embodiment, the present invention is a data transmission network comprising transmitting and receiving modems, operating as described above, to exchange data over a communications networks using a composite signal formed by mixing a data signal and a carrier signal. In a preferred implementation, the present method is used in connection with telephone communication networks. Specifically, the carrier and data waves are adapted as needed for high speed data transfer on telephone networks with a Nyquist limit maximum frequency of 4 kHz, caused by the 8 kHz sampling rate used by telephone switching equipment.

Similar techniques may likewise be employed on different types of communication networks, such as wireless or optical networks or other communication networks having different sampling rates. In these alternative implementations, the texture of the stepped sine wave may be modified or adapted as needed by changing the control circuits of the mixer to adapt the characteristics of the carrier wave and the data wave.

In summary, the present invention provides a system and method for increasing data transmission capacity over any transmission network. As can be seen, the increased data transmission capacity is achieved through physical transforms that function with any type of data and data encoding technique. Thus, in addition to increasing transmission rates over telephone networks, the present invention has broad applicability in a variety of data transmissions scenarios where benefits arise from increased data transmission capacity over a network. For example, increased bandwidth would have great benefits for digital broadcasts, such as High Definition TV (HDTV), video telephones, interactive gaming, Video/Audio on demand, Per-Per View (PPV) broadcasts, interactive shopping broadcasts, multi-channel audio, new movie releases, Voice over Internet Protocol (VOIP), etc. Similarly, increased bandwidth could be used in variety of systems to improve data transmission quality and reliability through various known techniques, such as oversampling, that would otherwise unacceptably decrease transmission rates.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIGS. 1A-B (Prior Art) illustrate block diagrams of known modem networks over communication networks;

FIG. 2 depicts the steps in a method for high-speed data transfer over communication networks using a composite waveform in accordance with embodiments of the present invention;

FIG. 3 depicts a high-level of a block diagram of a circuit for implementing the high-speed analog modem of FIG. 2 in accordance with embodiments of the present invention;

FIG. 4 illustrates a block diagram of a high-speed analog modem in accordance with embodiments of the present invention;

FIGS. 5A-B illustrate block diagrams of high-speed data transfer networks in accordance with embodiments of the present invention;

FIG. 6 depicts an exemplary data wave in accordance with embodiments of the present invention;

FIG. 7 depicts an exemplary carrier wave in accordance with embodiments of the present invention; and

FIG. 8 depicts an exemplary composite wave in accordance with embodiments of the present invention.

### DETAILED DESCRIPTION OF THE DRAWINGS

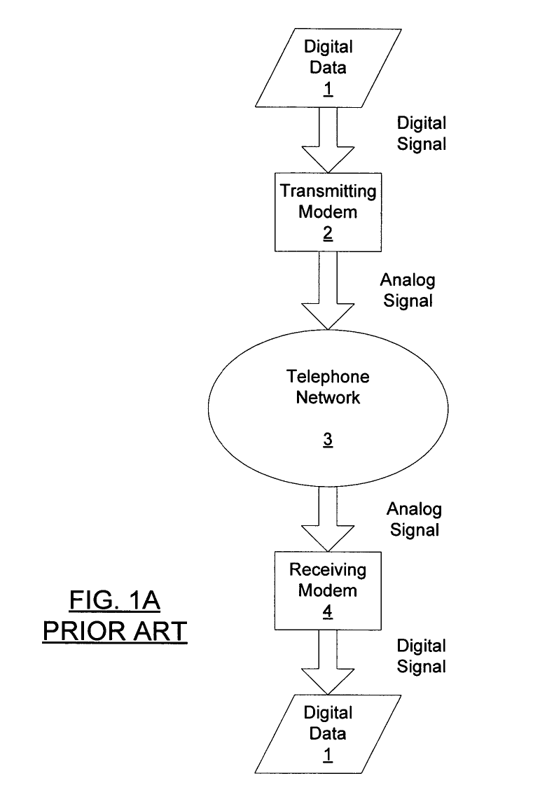

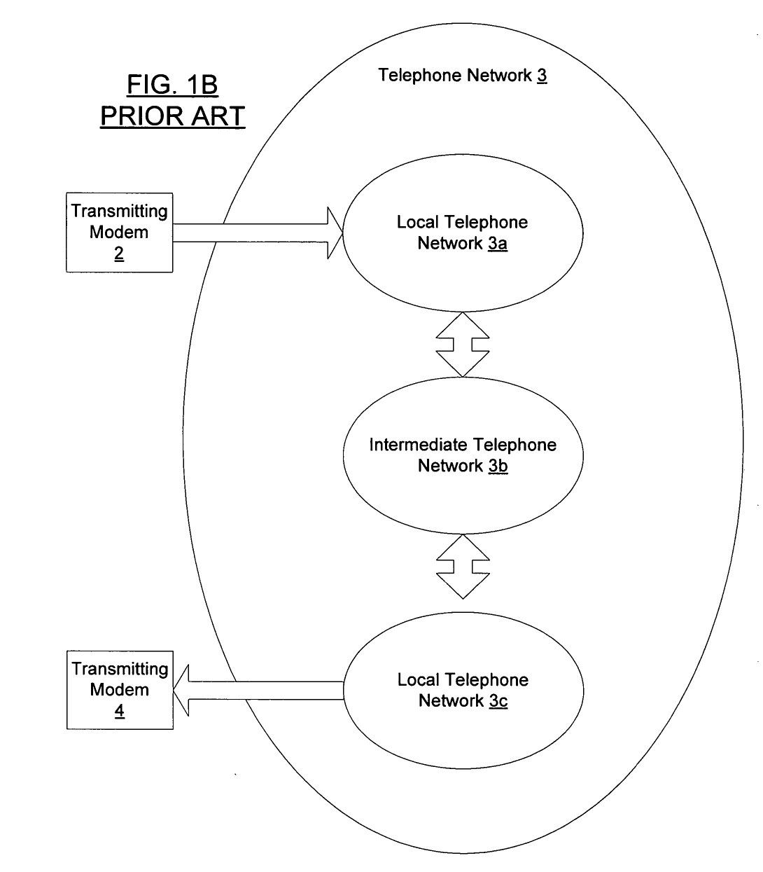

As depicted in FIG. 1A (PRIOR ART), a transmitting modem 2 is fed digital information 1. The transmitting modem 2 then analyzes this digital data 1 and converts (or modulates) the data into analog signals to be sent over a telephone network 3. A receiving modem 4 then receives these analog signals, converts them back into digital data 1 (in a process call modulation), and sends the data to a receiving computer. Thus, known modems consist essentially of paired Digital-to-Analog and Analog-to-Digital converters.

Even as telephone network 3 become increasingly digital, elements of the phone network 3 remain analog, as needed for voice transmissions. Referring now to FIG. 1B (PRIOR ART), local networks 3a and 3c enable telephone access to the transmitting and receiving modems, respectively 2 and 4. The analog local networks 3a and 3c represent subscriber loops that run to homes from telephone central office switching systems. A large portion of the telecommunications network 3, intermediate telephone network 3b, is digital. For example, the public switched telephone network (PSTN) is almost entirely digital. Thus, analog-to-digital and digital-to-analog conversions occur as transmissions pass through the phone network 3.

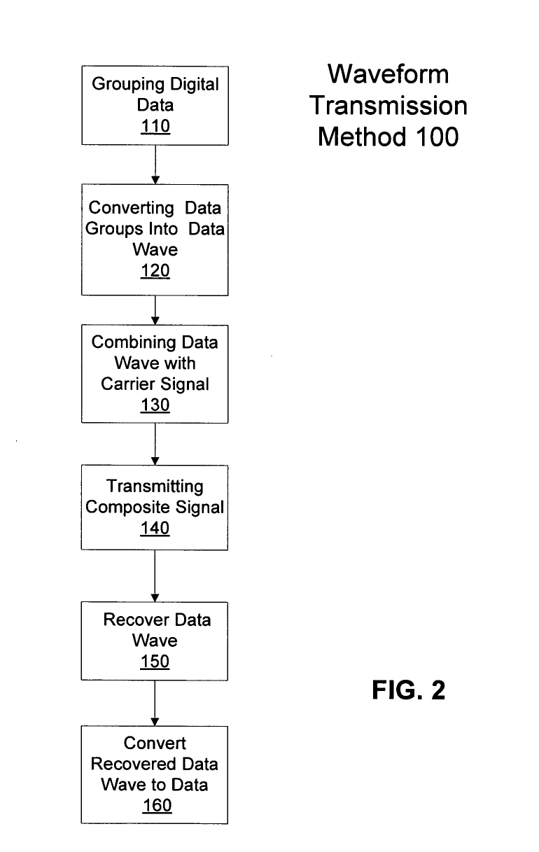

Turning now to FIG. 2, the present invention provides a composite waveform transmission method 100 for achieving high-speed transmission of digital data over a communication medium, such as the telephone network 3. The composite waveform transmission method 100 generally comprises the steps of grouping the digital data in step 110, converting the groups of digital data into a data signal in step 120, combining the data signal with a carrier signal adapted for transmission on the communications method in step 130, and transmitting the composite signal in step 140. At the receiving end, the composite signal is received and the data signal is recovered in step 150. The recovered data signal is then reconverted into digital data in step 160. Each of these steps in the composite waveform transmission method 100 is now examined in greater detail.

The digital data is grouped in step 110. The grouping of data is a generally well-known process in the field of computing. A stream of digital data may be fed into a memory bank of a desired size in order to create a data grouping through the use of a data strobe or other known means of creating data groupings, with the grouping in the memory bank being processed and transmitted, and the memory bank then being refilled with new data. In a preferred implementation, the digital data is organized in step 110 into groups of eight bits, or bytes. The eight bits in a byte represents 28 or 256 possible values. It is generally known in other fields, such as computer memory, to handle digital data in bytes or other sized groupings. It should be appreciated that the digital data may be organized into data groupings of any size according to the needs and constraints of the communication network and the desired performance.

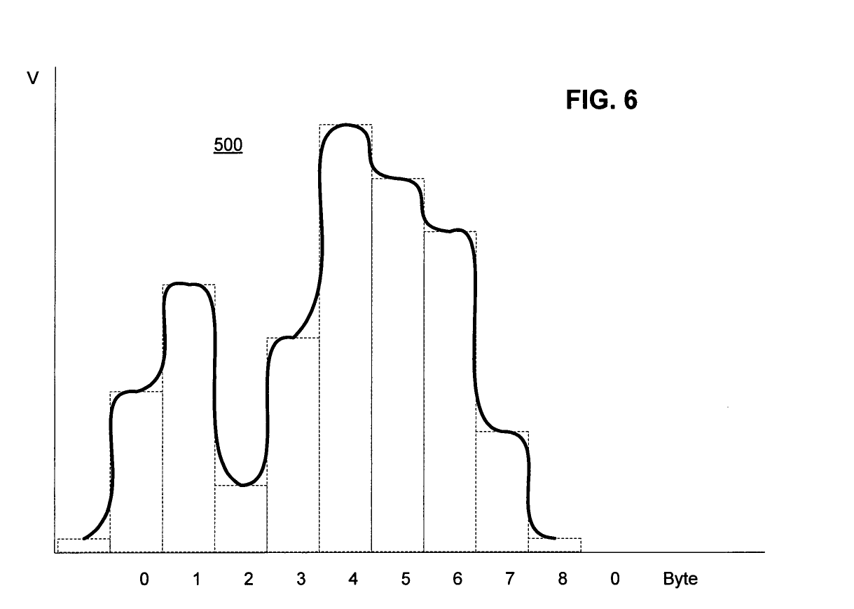

Continuing with the composite waveform transmission method 100 in FIG. 2, the data groups defined in step 110 are then converted into a data signal wave in step 120 according to the communication network of interest. For example, a data grouping to be transmitted over a conventional telephone network is converted into an electric signal wave. More specifically, each of the possible data groupings is converted into a distinct data signal, and the data signals are connected to form a data wave. Thus, 256 distinct electrical signals are assigned to each of the possible data byte values. Alternatively, the data groupings may be converted to optical or electro-magnetic data signals for transmission, respectively, on optical or wireless communication networks. The particular features and aspects of the data signal wave are described in greater detail below in the discussion of the data signal in FIG. 6 and the associated text.

Alternatively, steps 110 and 120 may entail a direct mapping of different data group values in various data signal values. For example, each of the possible byte values may be associated with a unique ASCII code symbol (a well-defined set of 256 computer characters). Distinct voltage levels may be predefined for each of the ASCII characters. A data wave may be formed by appending a series of electrical signals of varying voltage levels corresponding to different ASCII characters.

The conversion of the grouped data into a data signal in step 120 may optionally include placing a marker or other type of notation in the data signal wave to demarcate a separation between the translated data signals representing the data groupings. For example, a zero or null value may be placed between the data signals for each of the data groupings.

Continuing with the formation of the data wave in step 120, the data signals may also be repeated or encoded as needed to maximize data transmission accuracy and speed, as generally known in the field of digital data transmissions. For example, known modem standards often employ different digital data mapping and error correction techniques to improve accuracy. Thus, these and other known data transmissions technology may be incorporated into the principals of the present invention that relates to the high-speed transmission of digital data that is applicable to any data compression, mapping or error checking methods.

The representation of data groups as a waveform in step 120 means that two or more characters can simultaneously occupy the exact same time interval. As a result, the information content of the data wave may increase exponentially. Furthermore, the introduction of a wave character extends the utility of the impedance array to processes such as acoustics and radio frequency devices. Also, the embodiments of the present invention can operate on alternating voltages.

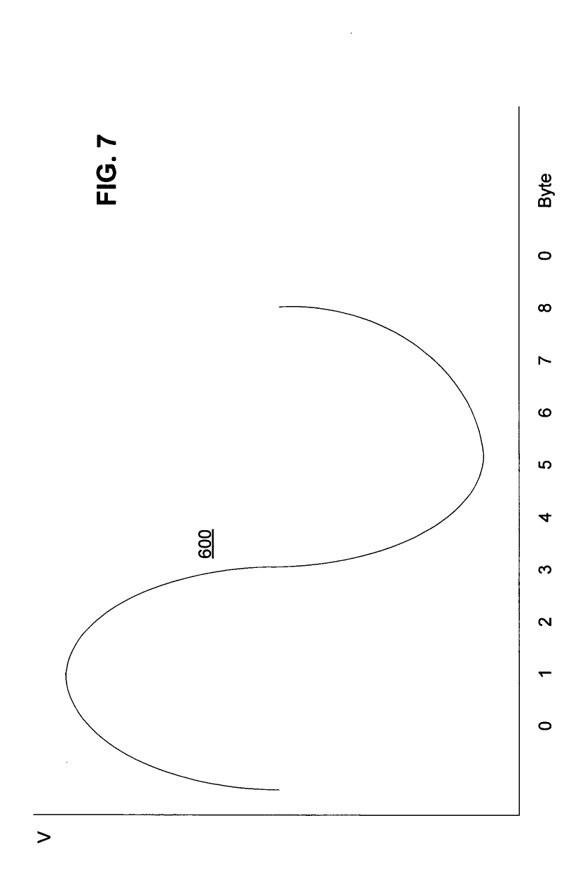

Returning to FIG.2, the composite waveform transmission method 100 next entails combining the data signal with a carrier wave adapted for transmission on the communications network in step 130. The particular features and aspects of the carrier wave are described in greater detail below in the discussion of the carrier wave with FIG. 7 and the accompanying text. The combining, or multiplexing, of two waves, such as the data and carrier waves, is a very well-known process in the field of communications. Multiplexing is the sending multiple signals or streams of information on a carrier at the same time in the form of a single, complex signal and then recovering the separate signals at the receiving end. In analog transmission, signals are commonly multiplexed using frequency-division multiplexing (FDM), in which the carrier bandwidth is divided into subchannels of different frequency widths, each carrying a signal at the same time in parallel. In digital transmission, signals are commonly multiplexed using time-division multiplexing (TDM), in which the multiple signals are carried over the same channel in alternating time slots. In some optical fiber networks, multiple signals are carried together as separate wavelengths of light in a multiplexed signal using dense wavelength division multiplexing (DWDM). In one implementation, the data and carrier waves may be combined though simple voltage signal addition.

The composite signal formed in step 130 is then transmitted over the communication network in step 140 according to known techniques and technology. Continuing with the example of a high speed data transmissions over telephone networks, as described in FIGS. 1A-1B, the composite wave is transmitted from a local loop to a central office, where the composite wave is sampled and converted for digital communications, and then reformed as an analog wave to be forwarded to a receiving modem.

Continuing with the composite wave transmission in step 140, the receive end may acquire the composite wave. In a preferred implementation, the received mixed signal may be amplified and passed through a 2.5 KHz Q-matched filter. The frequency of 2.5 KHz is reinforced from two directions. The first of these reinforcements is implemented by holding each 8-bit character analog equivalent voltage representation to a specified value for 50 microseconds. The second safeguard is that each 400-microsecond data interval begins and ends with a zero voltage level, maintained for 50 microseconds.

Continuing with FIG. 2, the data signal is recovered at the receiving end from the received composite signal, step 150. The recovery of the data signal generally includes a reversal of the composite wave formation in step 130. Specifically, the carrier wave is removed from the composite wave. The process of separating two waves, or demultiplexing, is very well known in the filed of communications. The physical characteristics of the carrier wave are predefined and can be exploited using known techniques to acquire the data wave. Typically, a reverse of the carrier wave may be applied to the composite signal to cancel or otherwise nullify the carrier wave.

The recovered data signal is then reconverted into digital data in step 160. The recovery of the data in step 160 generally includes reversing the data grouping of step 110 and the data wave formation of step 120. In step 160, portions of the data signal corresponding to data groups may be identified through markers added in step 120. For example, a null value may activate a data wave strobe that feeds sections of the data wave into a resistive array designed to reverse the encoding process of step 120. The inverted resistive array matrix returns the original data values, which are then transferred to a computer or other electronic device.

Other embodiments of the present invention provide a modem for enabling high-speed data over known communication networks, as described in FIGS. 1A-1B using the composite waveform method 100 described in FIG. 2 and the accompanying text. In particular, one implementation of the present invention provides an electronic circuit having various components that are selected and configured to perform the steps in the composite waveform method 100.

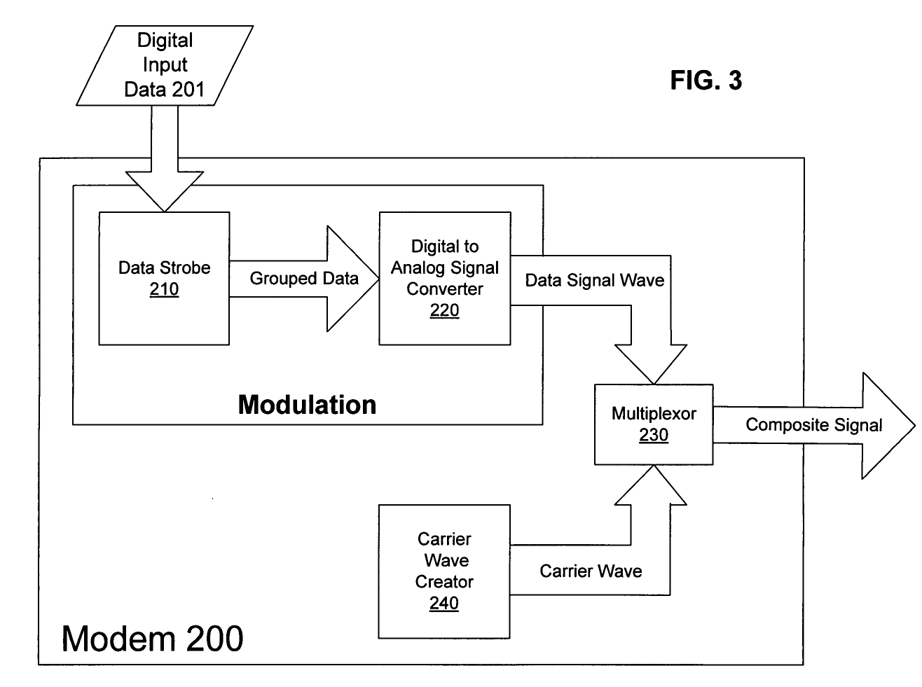

Turning now to FIG. 3, a high-level description of a modem 200 for implementing the composite wave method 100 is now described. The input data 201 in the form of a stream of bits representing one or zero values is controlled by a data strobe 210 that parses the data stream into fixed sized data groups. More specifically, the data strobe 210 is configured to open and close the transfer of digital data 201 into a digital-to-analog converter 220 at appropriate intervals so that data groupings are automatically created. One possible data strobe 210 is a square wave with fifty percent on/off cycle to form an input to the digital-to-analog converter 220.

The digital-to-analog converter 220 than changes the grouped data into an analog data wave representing the data values. Preferably, the digital wave is a set of closely packed amplitude pulses that are of fixed amplitude for a given time interval while being within the resolution of the receiver. As described in greater detail below, the DAC 220 may comprise a weighted resistive array that generates a voltage pulse of fixed time duration. However, it should be appreciated that other DACs (such as commercially available operation amplifiers) are known and may be used in the present invention. This process may then be repeated for another seven total bytes as the sequential data strobe 210 loads the DAC 220 with new data bytes. The resulting data wave has a grouping of eight voltage levels, as described below in FIG. 6 and the associated text. Each of the , thereby forming a data wave representing 264 possible bit values.

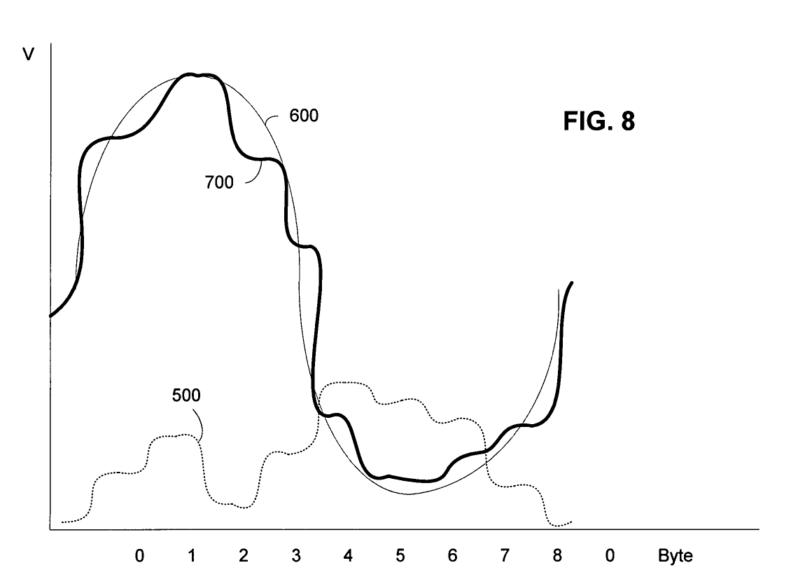

Continuing with FIG. 3, the resulting data wave is combined by a multiplexor 230 with a carrier wave produced by a carrier wave creator 240. Both of these components are well known in the communications field, and the particular components may be selected as needed to meet specific cost and performance needs. The carrier wave creator 240 typically produces an analog sine wave. The carrier wave is described in greater detail below in FIG. 7 and the accompanying text. Preferably, the analog sine transport wave has a frequency of 8 kHz to match the maximum sampling limit of convention telephone networks. The mixer 230 then combines the analog sine wave and the data wave, resulting in a stepped sine wave. For example, the mixer 240 may simply add the voltage levels of the data wave and the carrier wave to produce the composite wave as a stepped sine wave, as described below in FIG. 8.

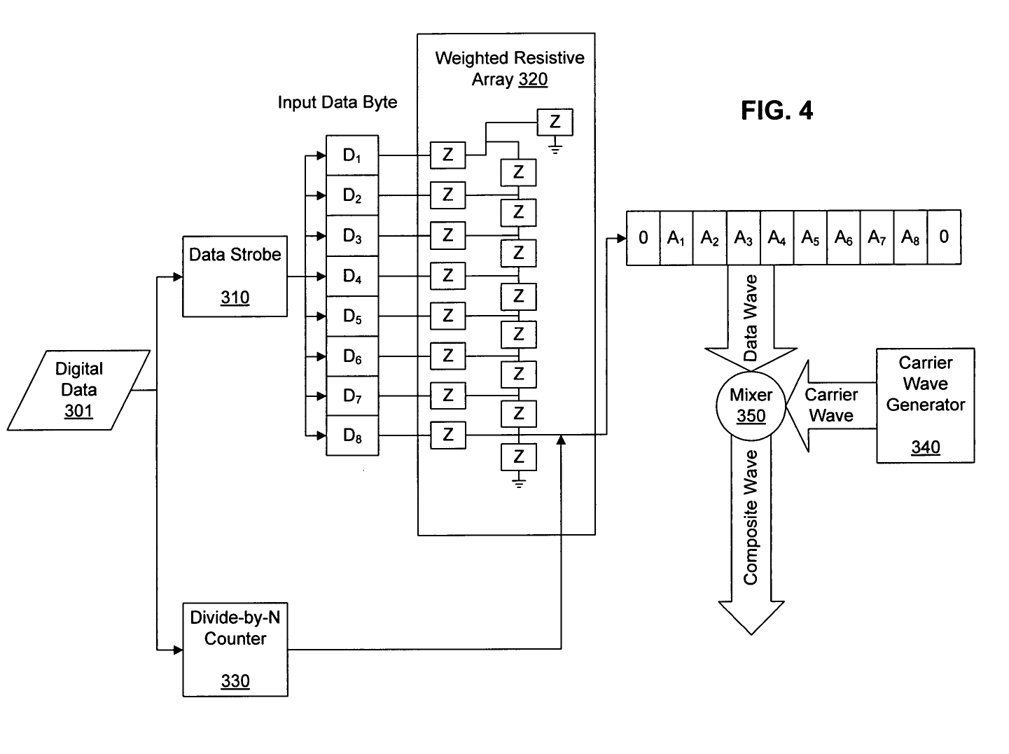

A particular embodiment of the present invention, a high-speed analog modem 300, is depicted in FIG. 4. The exemplary modem 300 has a digital-to-analog converter (DAC) that includes a sequential data strobe 310, a weighted resistive array 320, and a divide-by-N register 330. The operation of these components is now summarized. The digital data 301 is fed into a data strobe 310, corresponding to the data strobe 210 described above.

The exemplary modem 300 in FIG. 4 further includes the resistive array 320 for converting the data groupings into a data wave. The resultant voltage amplitude in the data wave is a weighted output, and this weighted output is a function of the resistive array configuration. In this way, the weighted resistive array 320 converts the grouped digital input into an analog voltage level, where each of the possible data grouping values has a unique associated voltage level. This voltage level is generally maintained for a time as needed to emulate the analog wave. The weighted resistive array 320 preferably has a minimum Eigen value, thereby ensuring that that data values may be recovered from the data wave through a reverse process.

The resistive array 320 is generally a traditional voltage ladder that employs various combinations of resistors in series and in parallel, depending on the input data values. The various resistors are triggered according the data values to create voltage drops in an input voltage to create various voltage outputs that correspond to each of the possible data values. For example, various additional resistors are brought into the resistive array 320 by the use of a Generalized Impedance Converter that enables the representation of a character in ASCCI or some other language as a unique wave representation. In one implementation, the resistive array 320 has a minimum of 416 micro volts occurring at 1.7 kHz.

The divide-by-N register 330 may be used to append a ninth analog data value in the data wave to indicate the start or end of the data grouping. The divide-by-N register 330 typically places a “0” or null value in the output data wave sequence between the data groupings. Thus, this “0” input added by the weighted analog converter data forms a clock signal representing the start or stop of the data pulse. In this way, the data 301 is converted into a data signal comprising groupings of nine voltages levels, where eight of the voltage levels correspond to a data byte (256 possible values) and a ninth voltage level indicates a data grouping.

The data wave (A₁A₂A₃A₄A₅A₆A₇A₈0) formed by the weighted resistive array 320 and the divide-by-N register 330 is then combined by a mixer 350 with a carrier wave produced by a carrier wave generator 340. The mixer 350 and the carrier wave generator 340 correspond to the similarly-named components mixer 230 and carrier wave creator 240 described above in FIG. 3. In particular, the mixer 350 may nonlinearly mix the data wave with an analog carrier wave from a class D audio amplifier carrier wave generator 340. The resultant mixed wave has sufficient analog characteristics for transport across a telephone wire.

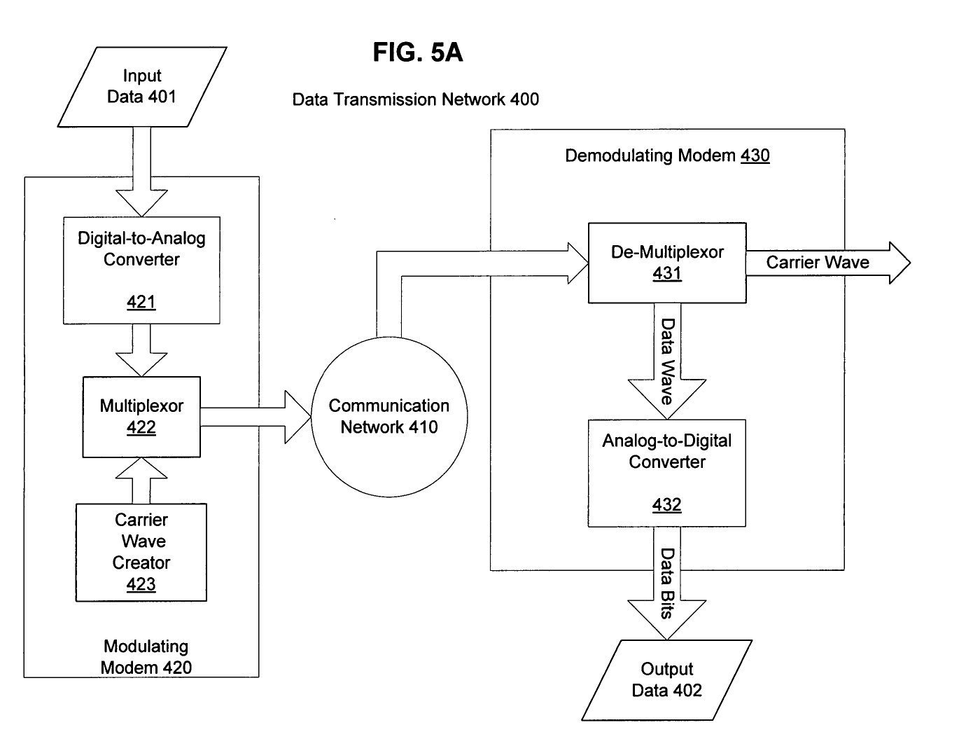

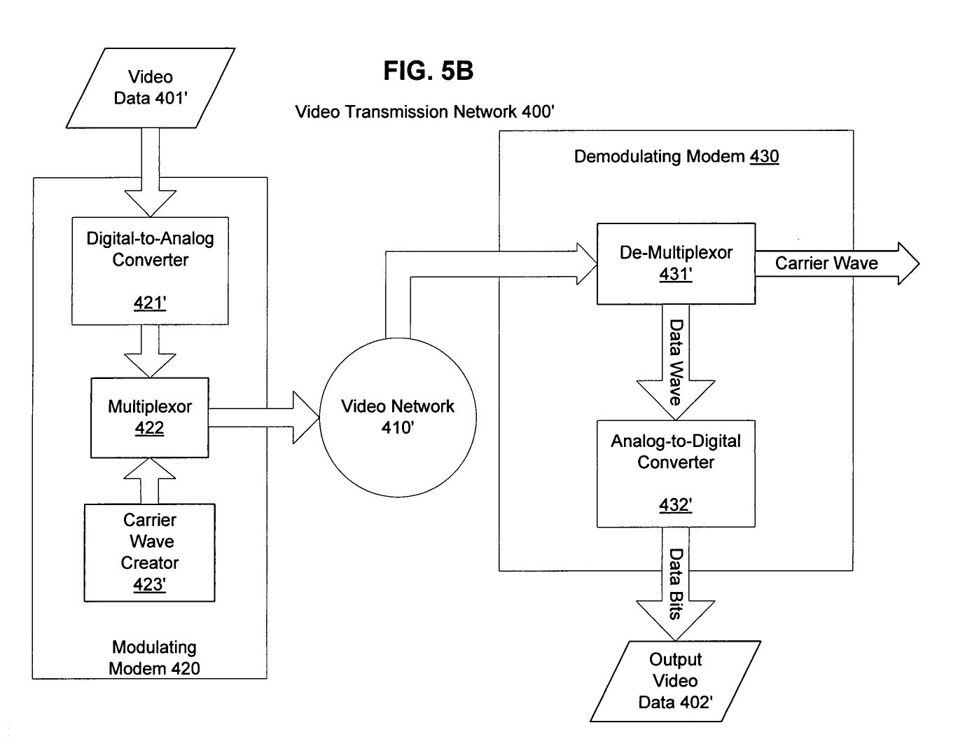

In another embodiment depicted in FIG. 5A, the present invention is a data transmission network 400 comprising transmitting and receiving modems, 420 and 430 to exchange input data 401 over a communications network 410 using a composite signal formed by mixing a data signal and a carrier signal. In a preferred implementation, the present method is used in connection with telephone communication networks. Specifically, the carrier and data waves are adapted as needed for high speed data transfer on telephone networks with a Nyquist limit maximum frequency of 4 kHz, caused by the 8 kHz sampling rate used by telephone switching equipment. The communication network 410 may be any analog medium, and may include a telephone network as described in FIGS. 1A-1B. The network 400 further includes a modulating modem 420, having a DAC 421, a multiplexor 422, and a carrier wave creator 423 that correspond, respectively, to the similarly titled DAC 220, multiplexor 230, and carrier wave 240 disclosed in FIG. 3.

The network 400 further includes a corresponding demodulating modem 430 that operates at the receiving end to receive and process the transmitted composite signal, generally a stepped sine wave. The receiving modem contains a demultiplexor 431 that recovers the data signal from the composite signal. As described above in the discussion of the composite wave method 100, various techniques are known for separating data wave from the carrier wave. Generally, the composite wave can be manipulated to cancel the carrier wave since the physical aspects of the carrier wave are known,.

An analog-to-digital converter 432 then decodes the data signal to reproduce the input data 401 contained therein. For example, a voltage meter may be used to detect each of the discrete voltage levels in the data wave, and a decoding table may associate each of the detected voltage levels with bit values. The voltage level is then inputted into to the decoding table to determine its equivalent binary output. In this way, a series of voltage signals may be decoded into digital values. It should be appreciated that numerous known devices may be employed to demodulate the signal detected by the voltage meter. For example, the above discussion of the weighted array 320 also describes the use of a corresponding resistive array using values corresponding to an inverted matrix to cancel out the effects of the weighted array 320, thereby returning the data wave to appropriate digital data values.

Similar techniques may likewise be employed on different types of communication networks 410, such as wireless or optical networks or other communication networks having different sampling rates and signal-to-noise ratios. In these alternative implementations, the texture of stepped sine wave may be modified or adapted as needed by changing the control circuits of the mixer to adapt the characteristics of the carrier wave and the data wave.

It should be appreciated that the system and method of the present invention may be used to increase data transmission capacity over any transmission network, and is not limited to telephone networks. As described above, the increased data transmission capacity is achieved through physical transforms that function with any type of data or data encoding technique. Thus, the present invention has broad applicability in a variety of data transmissions scenarios where benefits arise from increased data transmission capacity on any network. For example, increased bandwidth would have great benefits for digital broadcasts, such as High Definition TV (HDTV), video telephones, interactive gaming, Video/Audio on demand, Per-Per View (PPV) broadcasts, interactive shopping broadcasts, multi-channel audio, new movie releases, Voice over Internet Protocol (VOIP), etc.

Turning now to FIG. 5B, a video transmission system 400′ is now described. The video transmission system 400′ transmits video data 401′ over a video network 410′. The video data 401 is generally in a compressed digital form, such as a Motion Joint-Picture-Experts-Group (MPEG) movie file. The video data 401 is sent either automatically, such as a standard or High-Definition television broadcast, or in response to a user's request, such as Video-On-Demand (VOD). The video network 410′ typically is a cabled system such as a conventional cable system, or an over-the-air satellite transmission system. Furthermore, the video network 410′ may contain various components as known in the field of television broadcasts, and the video network 410′ may contain various segments where the transmitted is modified, converted, etc. as needed for transmission to a viewer. A digital-to-analog 421 converts the video data 401′ into an analog signal, where the conversion is specifically adapted for the needs of video data transmission over the video network 410′. Similarly, the carrier wave creator 423′ is specifically adapted for propagation over the video network 410. A multiplexer 422 combines the carrier wave and the analog video wave, and this composite wave is sent over the video network 410′ to a demodulating modem 430 included in a device, such as set-top box adapted to receive and decode the transmitted video data. The composite waveform allows the existing video network 410′ to carry a significantly greater amounts of video data, as needed to deliver video signals to more users and to deliver more video data to each user.

Continuing with FIG. 5B, the composite video/carrier signal is sent to a demuliplexor 431 adapted to separate the carrier wave and to recover the analog video wave. An analog-to-digital converter 432′ then converts the video wave back to output video data, reversing the operation of the digital-to-analog converter 421′. The resulting output video data 402′ is then sent to some type of output device that converts the digital output video data 402′ into an appropriate video and audio signal using known techniques.

Similarly, increased bandwidth could be used in variety of systems, such as the above described phone and video transmission systems 400 and 400′, to improve data transmission quality and reliability through various known techniques, such as oversampling, that could otherwise unacceptably decrease transmission rates.

FIG. 6 depicts a data wave 500 produced in accordance with various embodiments of the present invention. The data wave 500 contains discrete voltage levels for each possible combination of group digital data. For example, FIG. 6 depicts a data wave 500 corresponding to 8 bytes, each having an associated voltage level corresponding to the value of the 8 bits in each byte. Before and after the 8 bytes, a null or zero value is added to indicate the boundaries of the data grouping. The voltage levels in the data wave 500 are generally closely packed together so that peak variation is minimized. The data wave 500 is mixed with a carrier wave to form a composite wave that allows the closely packed voltage amplitudes to get through low pass filters in the telephone network. In this way, the present invention minimizes transmission performance degradation due to intersymbol interference.

At the same time, the method and apparatus of the present invention are further configured to insure that the voltage amplitudes of the transformed bytes represented in the data wave 500 are within the resolution of the receiver. As described above, the present invention features a close, adjacent placement of voltage pulses of varying amplitude to represent a byte. The voltage differential between the adjacent byte pulses should be within the resolution of the receiver for reliable decoding; i.e., the receiver should be able to detect the differences in the different data signals. In a preferred implementation, this is achieved by using the active span of the input binary number from the input transition. An inactive span consists of a number of consecutive numbers, i.e., the binary number 100001< active span 00< inactive span total 10000 100. All odd integers between 1 and 256 have an active span of 8. Using the concept of span, the input binary data can be directed to an appropriate resistive array that will adjust the amplitude to insure that the proper level of resolution is maintained.

FIG. 7 depicts a carrier wave 600 for transmission of data through a communications network. In the present invention, the carrier wave 600 is an analogue signal that is used only for the purpose of transmission. The carrier wave 600 is typically a sinusoidal transmission (such as a sine wave) and has various physical characteristics including amplitude, frequency and phase. The physical characteristics of the carrier wave may be adapted as needed for transmission over the communication network.

FIG. 8 depicts a composite wave 700 formed by modulating the carrier wave 600 to carry the information contained in the data wave 500. It may be noted that the carrier wave is mixed at a much higher voltage level than the data wave. Consequently, the physical characteristics of the carrier wave 600 (amplitude, frequency and phase) are generally preserved in the composite wave 700 when the digital data 500 wave is appended. The resulting carrier wave 700 is a sine wave with peaks and depressions along its sides, as depicted in FIG. 8. By preserving the characteristics of the carrier wave 600, the composite wave 700 may be carried over the communications network. The receiver then attempts to detect the peaks and depressions in the carrier wave 700 when the carrier wave 700 is examined. These variations are then converted back into the data wave 500 and the corresponding data values. As described above, the receiver must be able to detect the peaks and depressions in sides of the carrier wave 700 in order to decode the data contained on the wave.

### CONCLUSION

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. Many embodiments of the invention can be made without departing from the spirit and scope of the invention.

What is claimed:

1. A method for transferring digital data over an analog communications network, the method comprising the steps of:
organizing the digital data into one or more data groupings having a predetermined size;
converting each of the data groupings to an analog waveform, whereby each of the possible data combinations in the data grouping has a unique predefined analog waveform;
combining the analog wave forms for each of the data groupings to form a data wave;
forming a composite wave by mixing the data wave with a carrier wave adapted for transmission on the communications network;
transmitting the composite wave on the communications network;
recovering the data wave from the composite wave;
dividing the recovered data wave to reobtain the analog waveforms;
reconverting each of the analog waveforms to the associated data grouping; and
reorganizing the data groupings to obtain the digital data.

2. The method of claim 1, wherein the step of organizing the digital data comprises passing the data through a data strobe.

3. The method of claim 1 wherein the step of organizing the digital data comprises organizing the data into one or more bytes.

4. The method of claim 3, wherein the step of converting each of the data groupings to an analog waveform comprises associating each of the data bytes with a unique ASCII character and assigning a unique electrical charge for each of ASCII characters.

5. The method of claim 1, wherein the wherein the step of converting each of the data groupings to an analog waveform comprises passing each of the data groupings through a weighted resistive array, whereby a unique electrical signal is produced for each potential data grouping.

6. The method of claim 1, wherein the communication system is a telephone network.

7. The method of claim 6, wherein the carrier wave has a frequency of 8 kHz.

8. A method for transferring digital data over an analog communications network, the method comprising the steps of:
modulating the digital data to form a data wave;
forming a composite wave by mixing the data wave with a carrier wave adapted for transmission on the communications network;
transmitting the composite wave on the communications network;
recovering the data wave from the composite wave; and
demodulating the data wave to reacquire the digital data.

9. The method of claim 8, wherein the step of modulating the digital data to form a data wave comprises:
organizing the digital data into one or more data groupings having a predetermined size;
converting each of the data groupings to an analog waveform, whereby each of the possible data combinations in the data grouping has a unique predefined analog waveform.

10. The method of claim 9, wherein organizing the digital data into one or more data groupings comprises passing the digital data through a data strobe.

11. The method of claim 9 wherein the step of organizing the digital data comprises organizing the data into one or more bytes.

12. The method of claim 11, wherein the step of converting each of the data groupings to an analog waveform comprises associating each of the data bytes with a unique ASCII character and assigning a unique electrical charge for each of ASCII characters.

13. The method of claim 9, wherein the wherein the step of converting each of the data groupings to an analog waveform comprises passing each of the data groupings through a weighted resistive array, whereby a unique electrical signal is produced for each potential data grouping.

14. The method of claim 8, wherein the communication network comprises a digital telephone network.

15. The method of claim 14, wherein the carrier wave has a frequency of 8 kHz.

16. A modem for transferring digital data over an analog communications network, the system comprising:
a digital-to-analog converter to modulating the digital data into a data wave; and
a multiplexor that forms a composite wave by mixing the data wave with a carrier wave adapted for transmission on the communications network.

17. The modem of claim 16, wherein the digital-to-analog converter comprising:
a data strobe, said data strobe organizing the digital data into one or more data groupings having a predetermined size; and
a resistive array, said resistive array converting each of the data groupings to an analog waveform, whereby each of the possible data combinations in the data grouping has a unique predefined analog waveform.

18. The modem of claim 17, wherein the digital-to-analog converter further comprises a divide-by-n register to place a marker in the data wave to indicate a separation between portions in the data wave corresponding to a first and a second data grouping.

19. The modem of claim 16 wherein the digital-to-analog converter organizes the digital into one or more bytes and converts each possible data bytes into a unique ASCII character with an associated unique electrical charge for each of ASCII characters.

20. The modem of claim 16, wherein the communication system is a telephone network and wherein the carrier wave has a frequency of 8 kHz.

21. The modem of claim 16, wherein the data wave has a higher frequency than the carrier signal.

22. The modem of claim 16, wherein the data wave has a relatively lower amplitude than the carrier signal.

23. A system for transferring digital data over an analog communications network, the device comprising:
a first means for organizing the digital data into one or more data groupings having a predetermined size;
a second means for converting each of the data groupings to an analog waveform, whereby each of the possible data combinations in the data grouping has a unique predefined analog waveform;
a third means for combining the analog wave forms for each of the data groupings to form a data wave;
a fourth means forming a composite wave by mixing the data wave with a carrier wave adapted for transmission on the communications network; and
a sixth means for transmitting the composite wave on the communications network.

24. The system of claim 23 further comprising:
a seventh means for recovering the data wave from the composite wave;
an eighth means for dividing the recovered data wave to reobtain the analog waveforms;
a ninth means for reconverting each of the analog waveforms to the associated data grouping; and
a tenth means for reorganizing the data groupings to obtain the digital data.
